(19) United States
(12) Patent Application Publication
(10) Pub. No.: US 2020/0386812 A1
(43) Pub. Date: Dec. 10, 2020

(54) SERVER SWITCH SYSTEM INCLUDING FIELD-PROGRAMMABLE GATE ARRAY UNIT FOR PROCESSING DATA AND OPERATION METHOD THEREOF

(71) Applicants: Inventec (Pudong) Technology Corp., Shanghai (CN); Inventec Corporation, Taipei (TW)

(72) Inventors: Chih-Jen Chin, Taipei (TW); Lien-Feng Chen, Taipei (TW); Chung-Chih Li, Taipei (TW)

(21) Appl. No.: 16/572,540

(22) Filed: Sep. 16, 2019

(30) Foreign Application Priority Data
Jun. 6, 2019 (CN) 201910489662.2

(51) Int. Cl. G01R 31/3185; H03K 17/081; H04L 29/06

(52) U.S. Cl. CPC G01R 31/318519; H04L 63/0227; H03K 17/08116; G01R 31/318558

(57) ABSTRACT

A server switch system includes a switch unit and a field-programmable gate array (FPGA) unit. The switch unit includes a first switch interface for receiving the first data and sending the second data, and a second switch interface for sending the third data and receiving the fourth data. The switch unit is used to generate the third data according to the first data, and generate the second data according to the fourth data. The FPGA unit includes an FPGA interface coupled to the second switch interface for receiving the third data from the switch unit and sending the fourth data to the switch unit.

### BACKGROUND OF THE INVENTION

### 1. Field of the Invention

The disclosure is related to a server switch system and a method for operating the server switch system, and more particularly, a server switch system including a field-programmable gate array (FPGA) unit for processing data and a method for operating the server switch system.

### 2. Description of the Prior Art

In the field of server and switch, solutions related to network function virtualization (NFV) and software defined network (SDN) are available. The design concept of software defined network includes separating the control plane from the data plane in a network to centrally control the network with the control plane, making the network programmable. Network function virtualization can separate the network function from a network device to process the network function separately. Specifically, the above solutions can assign a function of a network to a processor to perform the function on the processor.

In order to perform the above solutions, a processor disposed on a switch can be used. However, a current switch often merely includes a small processor such as a microprocessor, and it often consumes a lot of processor resources to perform network function virtualization. Hence, a processor may become a bottleneck of a system, and the through-put and the efficiency of the system will be deteriorated.

### SUMMARY OF THE INVENTION

An embodiment provides a server switch system including a switch unit and a field-programmable gate array (FPGA) unit. The switch unit includes a first switch interface used to receive first data and send second data, and a second switch interface used to send third data and receive fourth data where the switch unit is used to generate the third data according to the first data and generate the second data according to the fourth data. The FPGA unit includes an FPGA interface coupled to the second switch interface and used to receive the third data from the switch unit and send the fourth data to the switch unit.

Another embodiment provides a method for operating a server switch system. The server switch system includes a switch unit and a field-programmable gate array (FPGA) unit. A second switch interface of the switch unit is coupled to a first FPGA interface of the FPGA unit. The method includes a first switch interface of the switch unit receiving first data; the switch unit using a packet filter to generate at least third data according to the first data; the switch unit sending the third data to the first FPGA interface through the second switch interface; the FPGA unit sending fourth data to the second switch interface through the first FPGA interface; the switch unit generating second data according to the fourth data; and the switch unit sending the second data through the first switch interface according to a rule.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a server switch system according to an embodiment.

FIG. 2 illustrates a method for operating the server switch system of FIG. 1 according to an embodiment.

FIG. 3 illustrates a server switch system according to another embodiment.

FIG. 4 illustrates a method for operating the server switch system of FIG. 3 according to an embodiment.

FIG. 5 illustrates a server switch system according to another embodiment.

FIG. 6 illustrates a method for operating the server switch system of FIG. 5 according to an embodiment.

FIG. 7 illustrates a structural diagram of the server switch system of FIG. 1, FIG. 3 and FIG. 5 according to an embodiment.

### DETAILED DESCRIPTION

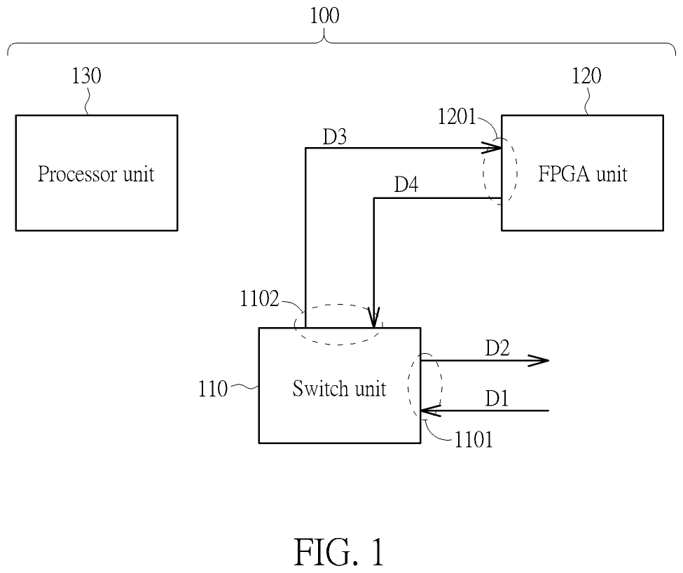

FIG. 1 illustrates a server switch system 100 according to an embodiment. The server switch system 100 may include a switch unit 110, a field-programmable gate array (FPGA) unit 120 and a processor unit 130. According to an embodiment, the switch unit 110 may be a chip with a switch function such as a system-on-chip (SoC). The FPGA unit 120 may include a field-programmable gate array. The processor unit 130 may include a central processing unit (CPU) or a microprocessor. Each of the first data D1 and second data D2 in the disclosure may include a packet, and each of the third data D3 to seventh data D7 may include a packet and/or data related to a packet.

According to an embodiment, the server switch system 100 may be a system having functions of a server and a switch concurrently. In other words, the server switch system 100 may include hardware providing functions of a switch. For example, the hardware may include the processor unit 130, a baseboard management controller, a basic input output system, a memory, a hardware, and so forth. Further, the server switch system 100 may include hardware providing functions of a switch, such as a device of network connection port.

As shown in FIG. 1, the switch unit 110 may include a first switch interface 1101 and a second switch interface 1102. The first switch interface 1101 may be used to receive the first data D1 from a backend and send the second data D2. The second switch interface 1102 may be used to send the third data D3 and receive fourth data D4. The switch unit 110 may be used to generate the third data D3 according to the first data D1 and generate the second data D2 according to the fourth data D4. As shown in FIG. 1, the FPGA unit 120 may include a first FPGA interface 1201 coupled to the second switch interface 1102 and used to receive the third data D3 from the switch unit 110 and send the fourth data D4 to the switch unit 110.

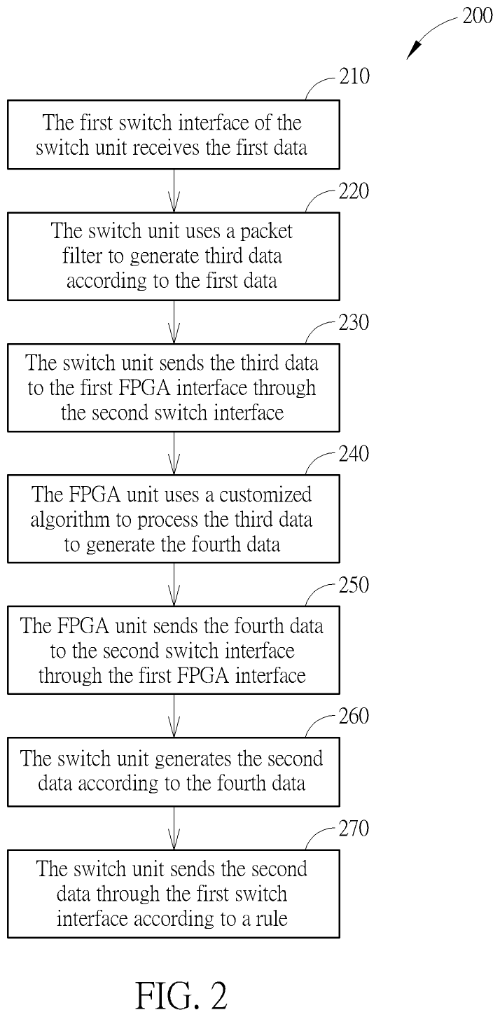

FIG. 2 illustrates a method 200 for operating the server switch system 100 of FIG. 1 according to an embodiment. As shown in FIG. 1 and FIG. 2, the method 200 may include the following steps.

Step 210: the first switch interface 1101 of the switch unit 110 receives the first data D1;

Step 220: the switch unit 110 uses a packet filter to generate third data D3 according to the first data D1;

Step 230: the switch unit 110 sends the third data D3 to the first FPGA interface 1201 through the second switch interface 1102;

Step 240: the FPGA unit 120 uses a customized algorithm to process the third data D3 to generate the fourth data D4;

Step 250: the FPGA unit 120 sends the fourth data D4 to the second switch interface 1102 through the first FPGA interface 1201;

Step 260: the switch unit 110 generates the second data D2 according to the fourth data D4; and

Step 270: the switch unit 110 sends the second data D2 through the first switch interface 1101 according to a rule.

In Step 220 and Step 230, the packet filter may be used to check a source address, a destination address, a packet type, a source communications port number and/or a destination communications port number of a packet (e.g., the first data D1), and the third data D3 corresponding to the first data D1 may be sent to the FPGA unit 120 accordingly. According to an embodiment, the first data D1 may be identical to the first data D1, or the switch unit 110 may process the first data D1 to generate the third data D3. In Step 240, the customized algorithm performed by the FPGA unit 120 may include (but not be limited to) algorithm(s) related to header modification, payload modification, encryption, decryption, compression and/or decompression. In Step 270, the mentioned rule may be defined by a user to control the sending of the second data D2. For example, the second data D2 may be sent to a backend. According to an embodiment, the second data D2 may be identical to the fourth data D4, or the switch unit 110 may process the fourth data D4 to generate the second data D2.

According to an embodiment of FIG. 1, the tasks of processing packets may be assigned to the FPGA 120. Hence, the processor unit 130 may offload the tasks of processing network functions, and the processor unit 130 may be reserved for other purposes.

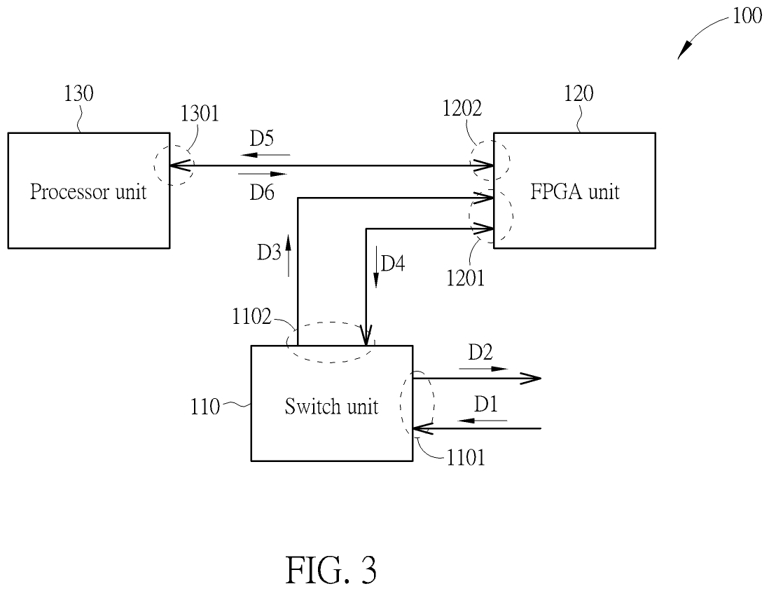

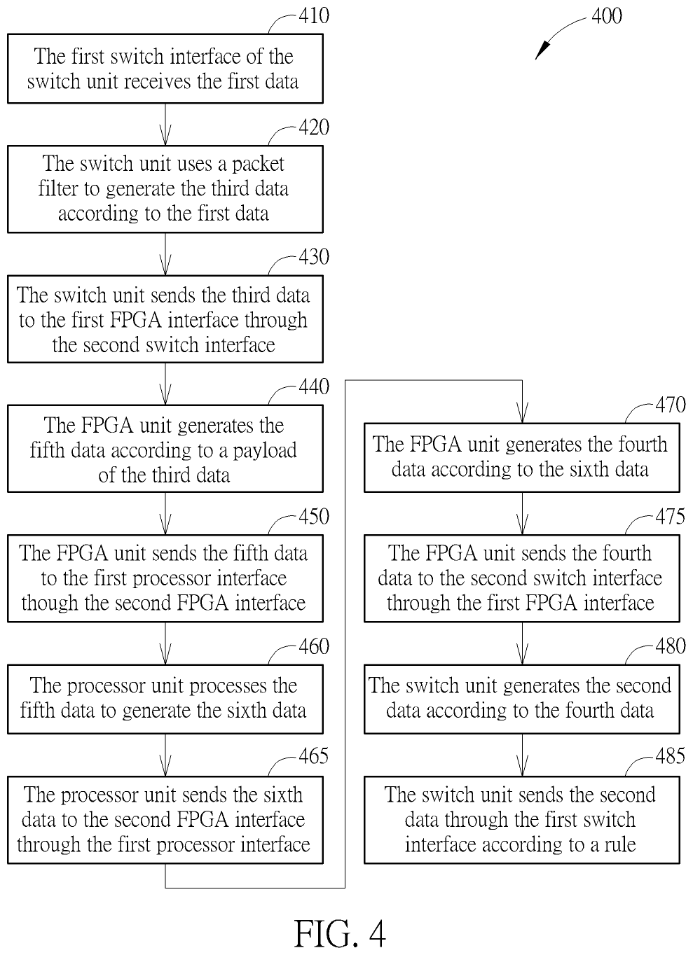

FIG. 3 illustrates a server switch system 100 according to another embodiment. The similarities of FIG. 3 and FIG. 1 are not repeated. As shown in FIG. 3, the processor 130 may include a first processor interface 1301 used to receive the fifth data D5 and send the sixth data D6. The FPGA unit 120 may further include a second FPGA interface 1202 coupled to the first processor interface 1301 for sending the fifth data D5 and receiving the sixth data D6. FIG. 4 illustrates a method 400 for operating the server switch system 100 of FIG. 3 according to an embodiment. As shown in FIG. 3 and FIG. 4, the method 400 may include the following steps.

Step 410: the first switch interface 1101 of the switch unit 110 receives the first data D1;

Step 420: the switch unit 110 uses a packet filter to generate the third data D3 according to the first data D1;

Step 430: the switch unit 110 sends the third data D3 to the first FPGA interface 1201 through the second switch interface 1102;

Step 440: the FPGA unit 120 generates the fifth data D5 according to a payload of the third data D3;

Step 450: the FPGA unit 120 sends the fifth data D5 to the first processor interface 1301 though the second FPGA interface 1202;

Step 460: the processor unit 130 processes the fifth data D5 to generate the sixth data D6;

Step 465: the processor unit 130 sends the sixth data D6 to the second FPGA interface 1202 through the first processor interface 1301; and

Step 470: the FPGA unit 120 generates the fourth data D4 according to the sixth data D6;

Step 475: the FPGA unit 120 sends the fourth data D4 to the second switch interface 1102 through the first FPGA interface 1201;

Step 480: the switch unit 110 generates the second data D2 according to the fourth data D4; and

Step 485: the switch unit 110 sends the second data D2 through the first switch interface 1101 according to a rule.

Step 410 to Step 430 and Step 475 to Step 485 may be similar to Step 210 to Step 230 and Step 250 to Step 270, so the steps are not repeatedly described. In Step 440 and Step 450, the payloads of the packets of the first data D1 and the third data D3 may be sent to the processor unit 130 through the fifth data D5. According to an embodiment, in Step 460, the processor unit 130 may perform data reorganization according to the fifth data D5 to generate the sixth data D6, and this may be a necessary initial process.

According to an embodiment, Step 450 to Step 465 may be repeated if necessary. For example, when the server switch system 100 is applied in an artificial intelligence (AI) application, such as deep learning (DL), Step 450 to Step 465 may be repeated, and data may be sent back and forth between the FPGA unit 120 and the processor unit 130 and be processed for a plurality of times. Hence, the inference operation of AI may be performed on the FPGA unit 120. According to an embodiment, in Step 470, packet(s) with abstract content may be generated to form the fourth data D4 according to the sixth data D6. As shown in FIG. 3 and FIG. 4, because a part of computation may be allotted to the FPGA unit 120, overloading the processor unit 130 to bottleneck the system can be avoided.

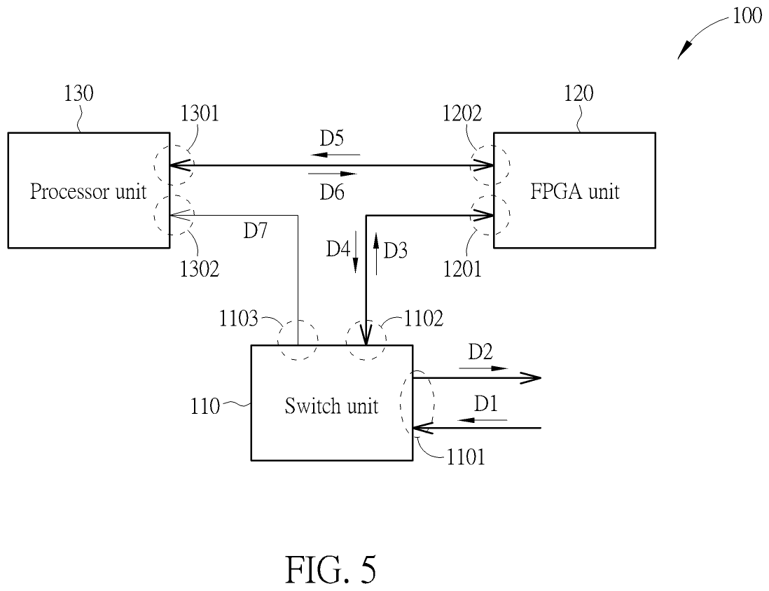

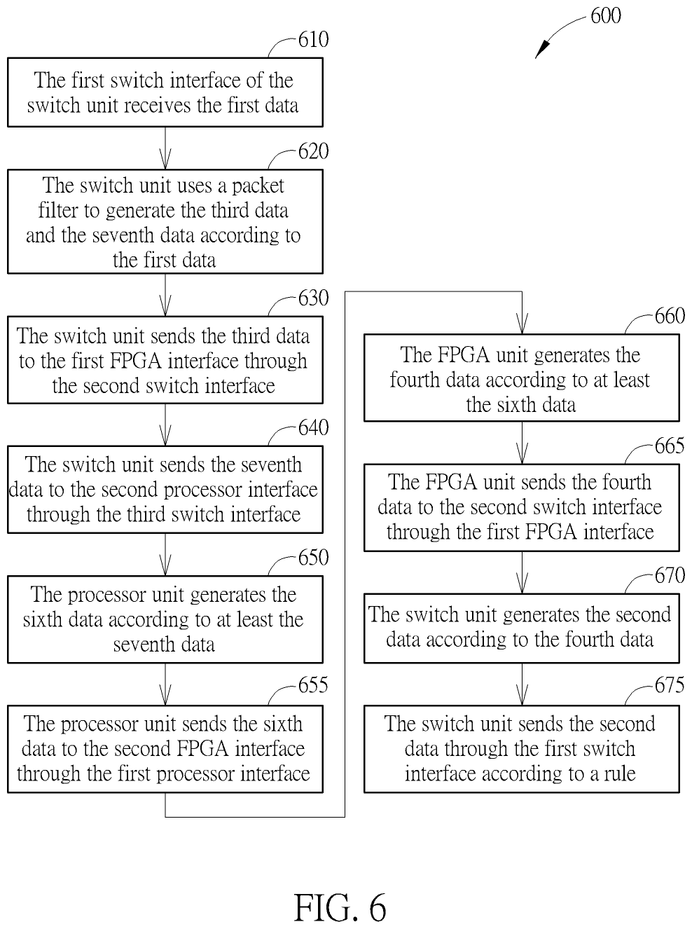

FIG. 5 illustrates a server switch system 100 according to another embodiment. The similarities of FIG. 5, FIG. 1 and FIG. 3 are not repeated. As shown in FIG. 5, the processor unit 130 may further include a second processor interface 1302 used to receive the seventh data D7. The switch unit 110 may further include a third switch interface 1103 coupled to the second processor interface 1302 for sending the seventh data D7. FIG. 6 illustrates a method 600 for operating the server switch system 100 of FIG. 5 according to an embodiment. As shown in FIG. 5 and FIG. 6, the method 600 may include the following steps.

Step 610: the first switch interface 1101 of the switch unit 110 receives the first data D1;

Step 620: the switch unit 110 uses a packet filter to generate the third data D3 and the seventh data D7 according to the first data D1;

Step 630: the switch unit 110 sends the third data D3 to the first FPGA interface 1201 through the second switch interface 1102;

Step 640: the switch unit 110 sends the seventh data D7 to the second processor interface 1302 through the third switch interface 1103;

Step 650: the processor unit 130 generates the sixth data D6 according to at least the seventh data D7;

Step 655: the processor unit 130 sends the sixth data D6 to the second FPGA interface 1202 through the first processor interface 1301;

Step 660: the FPGA unit 120 generates the fourth data D4 according to at least the sixth data D6;

Step 665: the FPGA unit 120 sends the fourth data D4 to the second switch interface 1102 through the first FPGA interface 1201;

Step 670: the switch unit 110 generates the second data D2 according to the fourth data D4; and

Step 675: the switch unit 110 sends the second data D2 through the first switch interface 1101 according to a rule.

Step 610, Step 630 and Step 665 to Step 675 may be similar to Step 210, Step 230 and Step 250 to Step 270 of FIG. 2, so the steps are not repeatedly described. In Step 620 to Step 640, the switch unit 110 may send the corresponding seventh data D7 to the processor unit 130 and send the corresponding third data D3 to the FPGA unit 120 according to a header of a packet of the first data D1. In Step 650, the processor unit 130 may modify a header and/or a payload of a packet of the seventh data D7 to generate the sixth data D6. In Step 660, the FPGA unit 120 may perform data reorganization according to at least the sixth data D6 to combine the payload back to generate the fourth data D4 accordingly. According to an embodiment, in Step 660, the FPGA unit 120 may generate the fourth data D4 according to the third data D3.

According to an embodiment, the data transmission path between the second processor interface 1302 and the third switch interface 1103 may have a lower bandwidth. Each of other data transmission paths (e.g., the paths used to send the first data D1 to the sixth data D6) may have a higher bandwidth. According to an embodiment, the structure of FIG. 5 and the method of FIG. 6 may be used for applications of SDN and be used to insert customized logic to modify a header and/or a payload of a packet. As shown in FIG. 5 and FIG. 6, because the FPGA unit 120 may share the workload of the processor unit 130, the processor unit 130 may be prevented from becoming a bottleneck of the system due to overload.

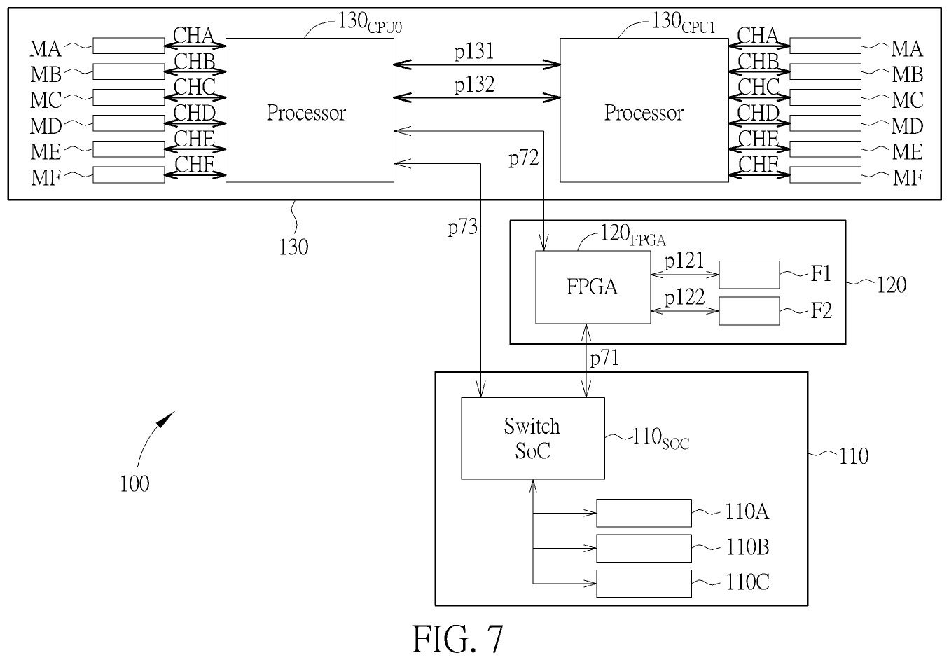

FIG. 7 illustrates a structural diagram of the server switch system 100 of FIG. 1, FIG. 3 and FIG. 5 according to an embodiment. As shown in FIG. 7, the switch unit 110 may include a switch system-on-a-chip (SoC) 110_{SOC}. The switch SoC 110_{SOC} may be coupled to connectors 110A to 110C. For example, the connectors 110A to 110C may include (but not limited to) quad small form-factor pluggable (QSFP) connectors, small form-factor pluggable (SFP) connectors and/or base-T connectors. The connectors 110A to 110C may support Gigabit Ethernet (GbE). For example, the connectors 110A to 110C may support 100 GbE, 25 GbE and 10 GbE. As shown in FIG. 7, the FPGA unit 120 may include an FPGA 120_{FPGA} and flash memories F1 and F2. The FPGA 120_{FPGA} may be coupled to the flash memories F1 and F2 through paths p121 and p122. The paths p121 and p122 may be paths of serial peripheral interface (SPI).

As shown in FIG. 7, the processor unit 130 may include processors 130_{CPU0} and 130_{CPU1}. The processors 130_{CPU0} and 130_{CPU1} may be coupled to one another through paths p131 and p132. The paths p131 and p132 may be paths of Ultra Path Interconnect (UPI). For example, the paths p131 and p132 may support 10.4 Giga Transmission per second (GT/s).

The FPGA unit 120 and the switch unit 110 may be coupled to one another through a path p71. The path p71 may be a path of Ethernet. For example, the path p71 may have a bandwidth of 100 Gigabit/sec. For example, the path p71 may be used to transceive the third data D3 and the fourth data D4 of FIG. 5. The processor unit 130 and the FPGA unit 120 may be coupled through a path p72. For example, the path p72 may be used to transceive the fifth data D5 and the sixth data D6 of FIG. 5.

The processor unit 130 and the switch unit 110 may be coupled to one another through a path p73. For example, the path p73 may be used to transceive the seventh data D7 of FIG. 5. The paths p72 and p73 may be paths of Peripheral Component Interconnect Express (PCIE) interface.

As shown in FIG. 7, each of the processors 130_{CPU0} and 130_{CPU1} may be coupled to memory modules MA to MF through paths CHA to CHF respectively. Each of the memory modules MA to MF may be a dual in-line memory module (DIMM). According to an embodiment, the processor unit 130 may be further coupled to a baseboard management controller (BMC). In another condition, the processor unit 130 may be coupled to a BMC through a south bridge chipset. The abovementioned BMC and south bridge chipset are not illustrated herein.

According to an embodiment, a path between the processor unit 130 and the switch unit 110 may have a higher bandwidth than prior art, and a path between the FPGA unit 120 and the switch unit 110 may also have a higher bandwidth than prior art. The FPGA unit 120 may process customized work items requiring higher performance or being more specific in nature. In the processor unit 130, a processor with high computing capability (e.g., 130_{CPU0} or 130_{CPU1} of FIG. 7) may process customized work items being more complicated in nature. The number of FPGAs (e.g., the FPGA 120_{FPGA} of FIG. 7) in the FPGA unit may be adjusted for different workload.

The structure shown in FIG. 7 is merely an example for providing more details related to FIG. 1, FIG. 3 and FIG. 5 instead of limiting the scope of embodiments. The details of the structure may be adjusted according to various requirements. According to an embodiment, a first layer to a third layer of a packet may be processed by the processor unit 110, and a fourth layer to a seventh layer may be processed by the FPGA unit 120. The abovementioned layers of a packet may be packet layers defined according to Open System Interconnection Reference Model (OSI model). Regarding applications, a header and a payload may be processed by the FPGA unit 120, and customized applications of the NFV technology and the SDN technology may be supported. Tasks of encryption, decryption, data compression and data decompression may be processed by the FPGA unit 120. Regarding applications of AI, a part of computing operations (e.g., computing operations related to inference) may be assigned to the FPGA unit 120 to be processed.

In summary, a system structure and a method provided by an embodiment may be used to realize the offload of the processor unit 110 and reduce the workload of the processor unit 100 to prevent a processor from becoming a bottleneck of a system. The overall throughput may be improved to minimize the problems of the field.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A server switch system comprising:
a switch unit comprising a first switch interface configured to receive first data and send second data, and a second switch interface configured to send third data and receive fourth data wherein the switch unit is configured to generate the third data according to the first data and generate the second data according to the fourth data; and
a field-programmable gate array (FPGA) unit comprising a first FPGA interface coupled to the second switch interface and configured to receive the third data from the switch unit and send the fourth data to the switch unit.

2. The server switch system of claim 1, wherein:
the switch unit uses a packet filter to generate the third data according to the first data; and
the FPGA unit generates the fourth data according to the third data.

3. The server switch system of claim 1 further comprising:
a processor unit comprising a first processor interface configured to receive fifth data and send sixth data;
wherein the FPGA unit further comprises a second FPGA interface coupled to the first processor interface and configured to send the fifth data and receive the sixth data.

4. The server switch system of claim 3 wherein the FPGA unit generates the fifth data according to a payload of the third data, the processor unit processes the fifth data to generate the sixth data, and the FPGA unit generates the fourth data according to the sixth data.

5. The server switch system of claim 3 wherein:
the processor unit further comprises a second processor interface configured to receive seventh data; and
the switch unit further comprises a third switch interface coupled to the second processor interface and configured to send the seventh data.

6. The server switch system of claim 5 wherein:
the switch unit uses a packet filter to generate the third data and/or the seventh data according to the first data;
the processor unit generates the sixth data according to at least the seventh data; and
the FPGA unit generates the fourth data according to at least the sixth data.

7. A method for operating a server switch system, the server switch system comprising a switch unit and a field-programmable gate array (FPGA) unit, a second switch interface of the switch unit being coupled to a first FPGA interface of the FPGA unit, the method comprising:
a first switch interface of the switch unit receiving first data;
the switch unit using a packet filter to generate at least third data according to the first data;
the switch unit sending the third data to the first FPGA interface through the second switch interface;
the FPGA unit sending fourth data to the second switch interface through the first FPGA interface;
the switch unit generating second data according to the fourth data; and
the switch unit sending the second data through the first switch interface according to a rule.

8. The method for operating the server switch system of claim 7, further comprising:
the FPGA unit using a customized algorithm to process the third data to generate the fourth data.

9. The method for operating the server switch system of claim 7, wherein the server switch system further comprises a processor unit, a processor interface of the processor unit is coupled to a second FPGA interface of the FPGA unit, and the method further comprises:
the FPGA unit generating fifth data according to a payload of the third data;
the FPGA unit sending the fifth data to the processor interface though the second FPGA interface;
the processor unit processing the fifth data to generate sixth data;
the processor unit sending the sixth data to the second FPGA interface through the processor interface; and
the FPGA unit generating the fourth data according to the sixth data.

10. The method for operating the server switch system of claim 7, wherein the server switch system further comprises a processor unit, a first processor interface of the processor unit is coupled to a second FPGA interface of the FPGA unit, a second processor interface of the processor unit is coupled to a third switch interface of the switch unit, and the method further comprises:
the switch unit using the packet filter to further generate seventh data according to the first data;
the switch unit sending the seventh data to the second processor interface through the third switch interface;
the processor unit generating sixth data according to at least the seventh data;
the processor unit sending the sixth data to the second FPGA interface through the first processor interface; and
the FPGA unit generating the fourth data according to at least the sixth data.
